(19) United States
(12) Patent Application Publication
(10) Pub. No.: US 2014/0188993 A1
(43) Pub. Date: Jul. 3, 2014

(54) METHOD AND APPARATUS FOR ANALYSIS OF SOCIAL MEDIA

(71) Applicant: MOTOROLA SOLUTIONS, INC., Schaumburg, IL (US)

(72) Inventors: DAVID E. KLEIN, DAVIE, FL (US); KENNETH W. DOUROS, SOUTH BARRINGTON, IL (US); CRAIG A. JANSSEN, ST. CHARLES, IL (US); STEVEN J. NOWLAN, SOUTH BARRINGTON, IL (US)

(73) Assignee: MOTOROLA SOLUTIONS, INC., SCHAUMBURG, IL (US)

(21) Appl. No.: 13/729,463

(22) Filed: Dec. 28, 2012

(51) Int. Cl. H04L 29/08

(52) U.S. Cl. CPC H04L 67/22
USPC 709/204

(57) ABSTRACT

A method and user terminal are provided that analyze social media by assembling a cluster of multiple social media contents, wherein each social media content of the multiple social media contents has one or more associated attributes, determining weights in association with the social media contents included in the cluster, and determining a reliability level of the cluster based on the determined weights. In various embodiments, determining weights may include determining a weight associated with each of one or more attributes shared by two or more of the multiple social media contents of the cluster and/or determining a social media content weight for each of two or more social media contents sharing an attribute. In still other embodiments, the method and user terminal may re-determine the reliability level in response to adding new social media content to the cluster.

### FIELD OF THE INVENTION

The present invention relates generally to social media aggregation systems and, in particular, to a method and apparatus for analyzing such social media.

### BACKGROUND OF THE INVENTION

Today, a significant amount of the population uses social media, such as Twitter© and Facebook©, to communicate with each other. This social media can serve as an effective informational tool for law enforcement agencies in tracking current events and researching past incidents. However, using social media as research tool poses a problem of determining a reliability of such information, such as distinguishing correct information from erroneous information and from information intended to mislead.

### BRIEF DESCRIPTION OF THE DRAWINGS

FIG. 1 is a block diagram of an exemplary communication system in accordance with an embodiment of the present invention.

FIG. 2 is a block diagram of a user terminal of the communication system of FIG. 1 in accordance with an embodiment of the present invention.

FIG. 3 is a logic flow diagram illustrating a method performed by the user terminal of the communication system of FIG. 1 in analyzing social media accordance with some embodiments of the present invention.

FIG. 4 is an exemplary block diagram illustrating multiple clusters, each cluster comprising multiple social media contents, in accordance with some embodiments of the present invention.

FIG. 5A is a logic flow diagram illustrating an exemplary method performed by the user terminal of the communication system of FIG. 1 in determining, and updating, reliability levels and individual and cluster-wide attribute weights in accordance with some embodiments of the present invention.

FIG. 5B is a continuation of the logic flow diagram of FIG. 5A illustrating a method performed by the user terminal of the communication system of FIG. 1 in determining, and updating, reliability levels and individual and cluster-wide attribute weights in accordance with some embodiments of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for an effective informational tool for law enforcement agencies in tracking current events and researching past incidents, a method and user terminal are provided that analyze social media by assembling a cluster of multiple social media contents, wherein each social media content of the multiple social media contents has one or more associated attributes, determining weights in association with the social media contents included in the cluster, and determining a reliability level of the cluster based on the determined weights. The method and user terminal then may utilize the determined reliability level to generate further actions, such as dispatching law enforcement officers to a location or to search for a person, or to predict a reliability level of further social media content. In various embodiments, determining weights may include determining a weight associated with each of one or more attributes shared by two or more of the multiple social media contents of the cluster and/or determining a social media content weight for each of two or more social media contents sharing an attribute. In still other embodiments, the method and user terminal may re-determine the reliability level in response to adding new social media content to the cluster.

Generally, an embodiment of the present invention encompasses a method for analyzing social media. The method includes assembling a cluster of a plurality of social media contents, wherein each social media content of the plurality of social media contents has one or more associated attributes, determining weights in association with the social media contents included in the cluster, and determining a reliability level of the cluster based on the determined weights.

Another embodiment of the present invention encompasses a user terminal comprising a user interface and a processor that is configured to assemble a cluster of a plurality of social media contents, wherein each social media content of the plurality of social media contents has one or more associated attributes, determine weights in association with the social media contents included in the cluster, and determine a reliability level of the cluster based on the determined weights.

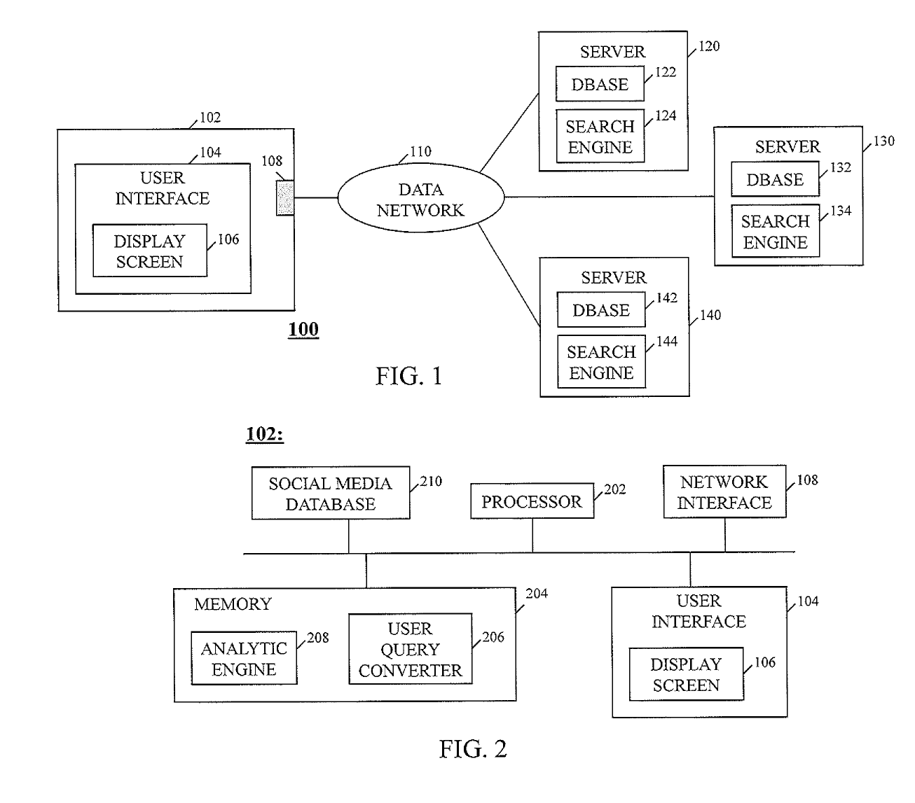

Turning now to the drawings, the present invention may be more fully described with reference to FIGS. 1-5B. FIG. 1 is a block diagram of an exemplary communication system 100 in accordance with an embodiment of the present invention. Communication system 100 includes a user terminal 102 connected to multiple servers 120, 130, 140 (three shown) via a data network 110. Data network 110 may comprise a wide area network (WAN), a local area network (LAN), a telephone network such as a Public Switched Telephone Network (PSTN), the Internet, a privately operated data network such as an enterprise network, a wireless network such as a cellular network or a Wireless LAN (WLAN), a Public Safety network, or a combination of networks.

User terminal 102 may be any kind of user device into which a user may enter a data query and which includes a display for displaying results of that query. More particularly, user terminal 102 includes a user interface 104 via which a user may input a data query into the user terminal, and a display screen 106 for displaying the data query and results of a corresponding data search. For example, user terminal 102 may be a wireless mobile device, such as a cellular telephone, a radio telephone, a smart phone, or a personal digital assistant (PDA) with radio frequency (RF) capabilities, may be a personal computer, a laptop computer, or a tablet computer with or without radio frequency (RF) capabilities, or may be a communication console, such as used in a computer-assisted dispatch (CAD) system, for example, a Public Safety system. User terminal further includes a network interface 108, for example, a wireless, wireline, or optical interface, for connecting to data network 110.

Servers 120, 130, and 140 each includes a respective database 122, 132, and 142 that may be searched by user terminal 102. More particular, servers 120, 130, and 140 each includes a respective server entity that may collect, process, and maintain data in the corresponding database 122, 132, and 142 and a respective search engine 124, 134, and 144 that may search the database, or other databases that may be internal or external to the server, in response to receiving a query from user terminal 102. In other embodiments of the present invention, one or more of search engines 124, 134, 144 may be external to, and in communication with, a corresponding server 120, 130, and 140. Servers 120, 130, and 140 each may be connected to data network 110 via any of a wireless, wireline, or optical connection, or any other connection known in the art. Databases 122, 132, and 142 are repositories of social media content, such as video recordings, audio recordings, emails, tweets, Facebook© entries, criminal records (such as a Records Management Service (RMS)), and/or any other social media content.

Further, it is assumed herein that the social media content stored in databases 122, 132, and 142 is stored in association with one or more attributes of the content. A social media content attribute may be any descriptor of the content that may be searched by a database search engine. For example, such attributes may be: a ‘source,’ that is, an identifier of a source (for example, a person) of the content; a ‘content location,’ that is, a location associated with the occurrence of an event depicted in the content (for example, any one or combination of location parameters, such as a discrete location like a jewelry store and or a pub, a street intersection, a city, or Global Positioning Satellite (GPS) coordinates); a ‘source location,’ that is, a location associated with the source when posting the content, a ‘content time,’ that is, a time associated with the occurrence of an event depicted in the content; a ‘posting time,’ that is, a time that the content was posted; a ‘victim,’ that is, a victim of an event depicted in the content; a ‘perpetrator,’ that is, a ‘perpetrator’ of an event depicted in the content; an ‘event,’ that is, the event associated with the content (for example, a concert, an athletic event, a car theft, a robbery, or a shooting); and ‘relatives/associates/group members,’ that is, a listing of a person and his/her known relatives and/or associates or a groups, such as a gang, and known members of the group (for example, which relationships may be maintained in records in an RMS database). This list of attributes is provided to illustrate the principles of the present invention and is not intended to be a comprehensive listing of all attributes that may be associated with social media content.

From another perspective, the social media content may be thought of as being represented by a multi-dimensional vector whose parameters are, for example, ‘source,’ ‘content location,’ ‘source location,’ ‘content time,’ ‘posting time,’ ‘victim,’ ‘perpetrator,’ ‘event,’ and ‘relatives/associates/group members.’

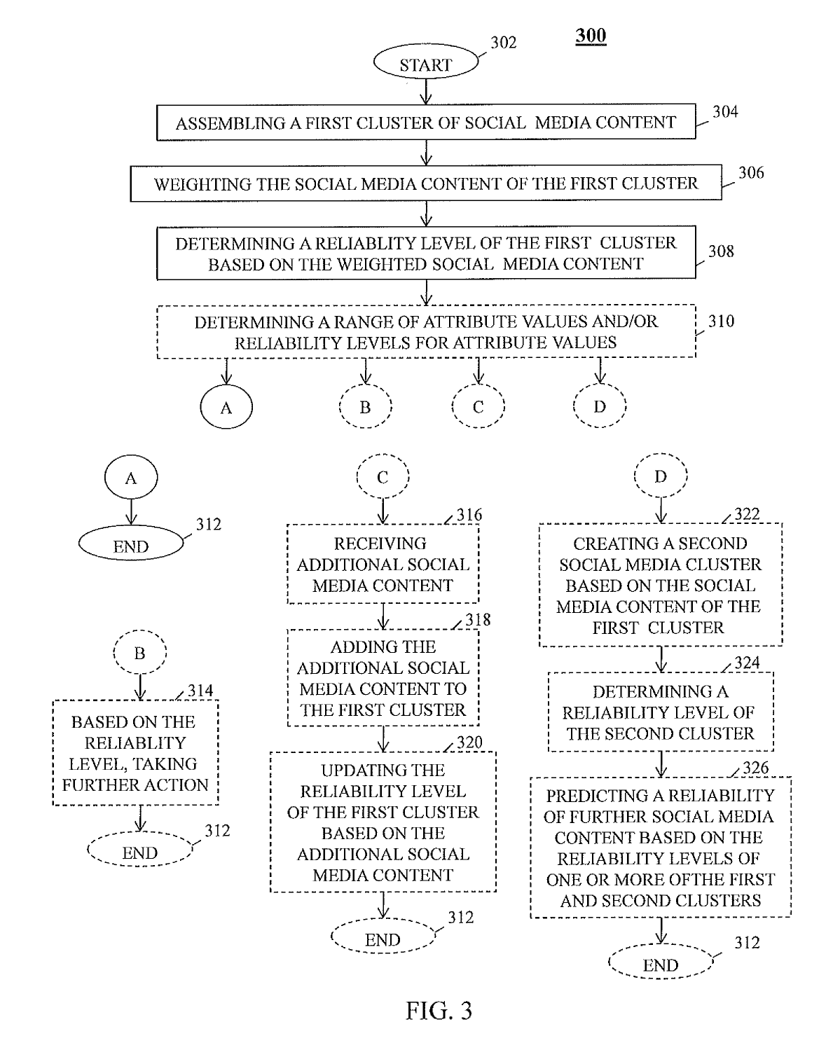

Referring now to FIG. 2, a block diagram is depicted of user terminal 102 in accordance with various embodiments of the present invention. User terminal 102 includes a processor 202, such as one or more microprocessors, microcontrollers, digital signal processors (DSPs), combinations thereof or such other devices known to those having ordinary skill in the art. The particular operations/functions of processor 202, and thus of user terminal 102, is determined by an execution of software instructions and routines that are stored in a respective at least one memory device 204 associated with the processor, such as random access memory (RAM), dynamic random access memory (DRAM), and/or read only memory (ROM) or equivalents thereof, that store data and programs that may be executed by the corresponding processor. However, one of ordinary skill in the art realizes that the operations/functions of processor 202 alternatively may be implemented in hardware, for example, integrated circuits (ICs), application specific integrated circuits (ASICs), a programmable logic device such as a PLD, PLA, FPGA or PAL, and the like, implemented in the user computer device. Based on the present disclosure, one skilled in the art will be readily capable of producing and implementing such software and/or hardware without undo experimentation.

User terminal 102 further includes user interface 104 and network interface 108, which user interface and network interface each is coupled to processor 202. As described above, network interface 108 may be a wireless, wireline, or optical interface capable of conveying messaging, such as data packets, to, and receiving messaging from, data network 110. User interface 104 includes display screen 106, which display screen may or may not comprise a capacitive touchscreen, and further may include a keypad, buttons, a touch pad, a joystick, a mouse, an additional display, or any other device useful for providing an interface between a user and an electronic device such as user terminal 102. Display screen 106 may be a liquid crystal display (LCD), a light emitting diode (LED) display, a plasma display, or any other means for visually displaying information.

At least one memory device 204 includes a user query converter module 206 and an analytic engine 208. User query converter module 206, when executed by processor 202, converts a user's query, received from a user via user interface 104, into a machine readable format, that is, searchable code that may be executed by a search engine, such as search engines 124, 134, 144 of servers 120, 130, 140. In response to user terminal 102 receiving content based on the search query, analytic engine 208, when executed by processor 202, then assigns weights and a reliability factor to the content. User terminal 102 then may display the retrieved content, and associated weights and/or reliability factor, on display screen 106.

User terminal 102 further includes a social media database 210 that is in communication with processor 202, which database stores social media content retrieved, or downloaded, by the user terminal, for example, from databases 122, 132, and 142. The social media content is stored in association with a history of reliability levels determined for the social media content. However, in another embodiment of the present invention, social media database 210 may maintained in an infrastructure device external to, and accessible, by the user terminal.

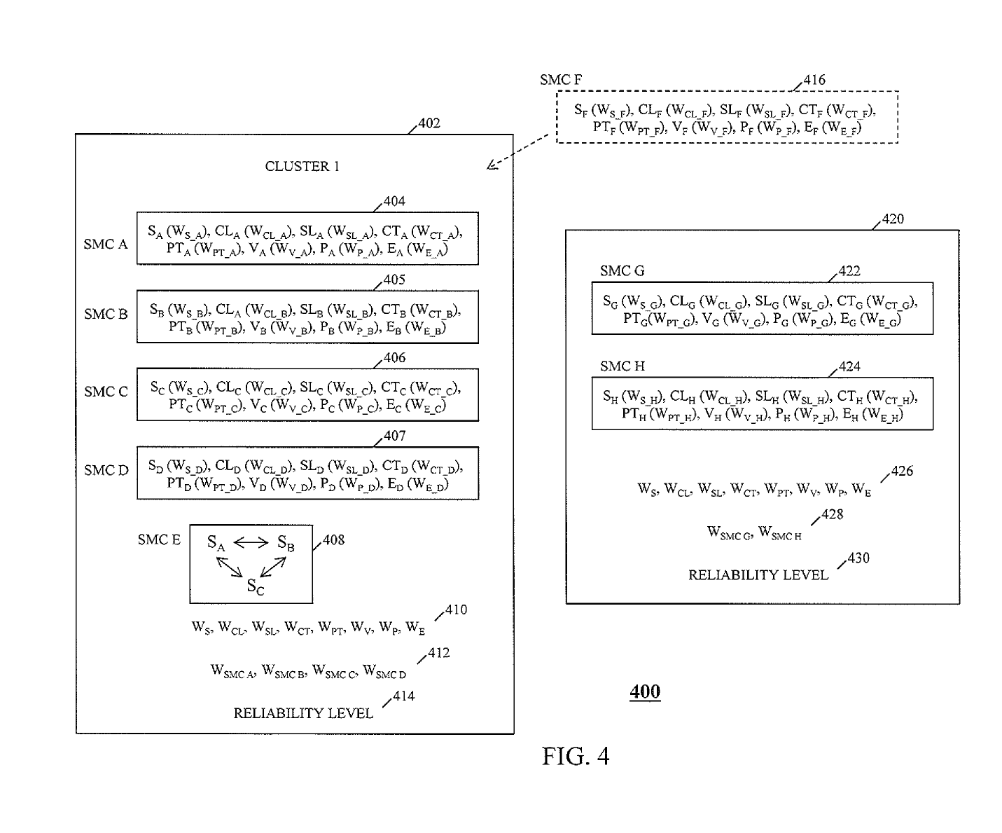

Referring now to FIG. 3, a logic flow diagram 300 is provided that illustrates a method performed by user terminal 102 in analyzing social media accordance with some embodiments of the present invention. Logic flow diagram 300 begins (302) when user terminal 102 assembles (304) a first ‘cluster’ of social media content. The first cluster comprises a collection of related social media content. In various embodiments, user terminal 102 may assemble the first ‘cluster’ by retrieving the social media content from one or more of the multiple databases 122, 132, 142 in accordance with known techniques and/or by receiving social media content from a source of the content, for example, from a police officer submitting a police report.

In assembling a cluster, user terminal 102 searches for social media content having particular values for the associated attributes. For example, a value associated with a ‘content location’ or ‘source location’ attribute may be an intersection, a specific store, a store-type (e.g., a jewelry store), a neighborhood, a city, or GPS coordinates with respect to location. By way of another example, a value associated with a ‘content time’ or ‘posting time’ attribute may be, for example, a time of day, a date, a month, or a year. By way of yet another example, a value associated with a ‘source,’ victim,’ or ‘perpetrator’ parameter may be a name, a face, or any other identifier that may uniquely identify a person.

Social media contents may have related values for the ‘source’ attribute when a source of one social media content is a relative of, or a known associate of, a source of the other social media content. Whether two sources are relatives of, or known associates of, each other may be determined, for example, by reference to records downloaded by user terminal 102 from an RMS database. By way of another example, two social media contents may have related values for the ‘content location’ or ‘source location’ attribute when they are sufficiently close in location to each other, for example, occurring at addresses, street intersections, neighborhoods, or stores that are close by each other. By way of yet another example, two social media contents may have related values for the ‘content time’ or a ‘posting time’ attribute when they are sufficiently close in time to each other, for example, when their difference in time is less than a difference threshold. A determination of what values are sufficiently close to each other so as to considered to be ‘related’ is up to a designer of communication system 100 or a person assembling the cluster.

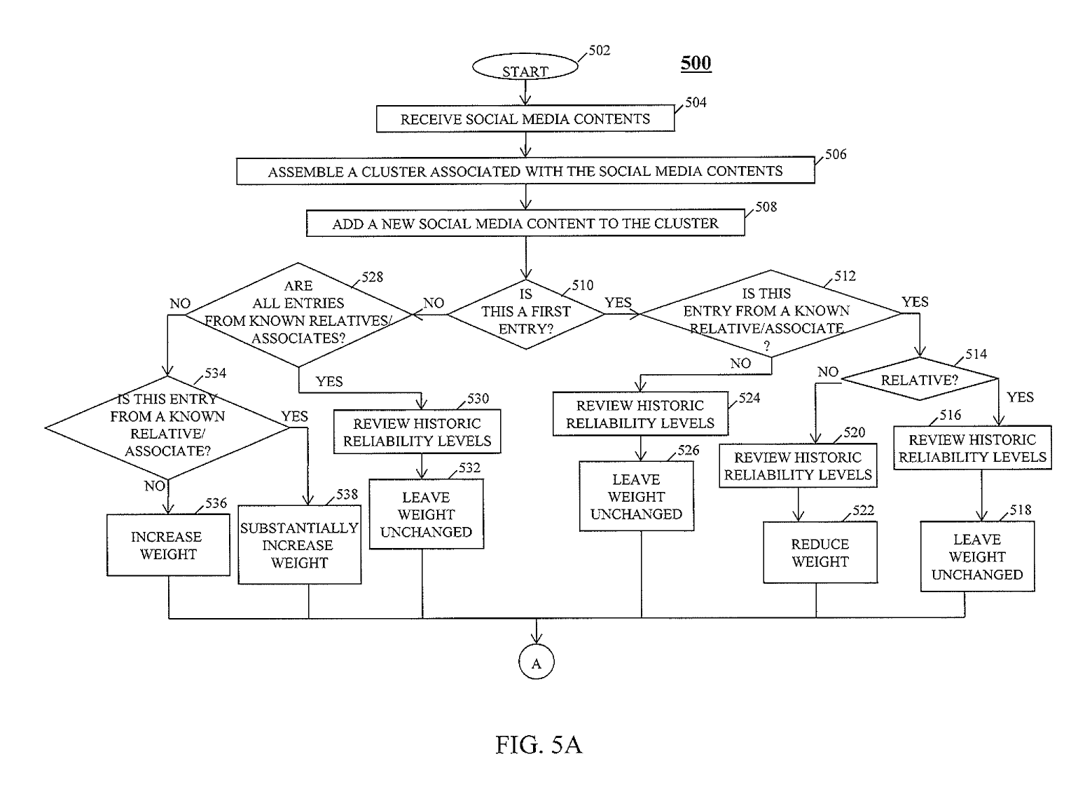

For example, FIG. 4 is an exemplary block diagram 400 is provided that illustrates multiple clusters, each comprising multiple social media contents 404-408, such as video recordings, Facebook© entires, tweets, emails, and so on, in accordance with some embodiments of the present invention. A first cluster 402 depicted in FIG. 4 comprises multiple social media contents 404-408. Each social media content 404-408 is associated with one or more attributes, such as a source (S) of the content, an event (E) associated with the content, a content location (CL) associated with the event depicted in the content, a source location (SL) associated with the source when posting the content, a content time (CT) associated with the occurrence of the event depicted in the content, a posting time (PT) that that the content was posted, a victim (V) of the event depicted in the content, and a perpetrator (P) of the event depicted in the content.

For example, social media content A (SMC A) 404 is associated with a source value S_{A}, a content location value CL_{A}, a source location value SL_{A}, a content time value CT_{A}, a posting time value PT_{A}, a victim value V_{A}, a perpetrator value P_{A}, and an event value E_{A}. Similarly, social media content B (SMC B) 405 is associated with a source value S_{B}, a content location value CL_{B}, a source location value SL_{B}, a content time value CT_{B}, a posting time value PT_{B}, a victim value V_{B}, a perpetrator value P_{B}, and an event value E_{B}; social media content C (SMC C) 406 is associated with a source value S_{C}, a content location value CL_{C}, a source location value SL_{C}, a content time value CT_{C}, a posting time value PT_{C}, a victim value V_{C}, a perpetrator value P_{C}, and an event value E_{C}; and social media content D (SMC D) 407 is associated with a source value S_{D}, a content location value CL_{D}, a source location value SL_{D}, a content time value CT_{D}, a posting time value PT_{D}, a victim value V_{D}, a perpetrator value P_{D}, and an event value E_{D}. Further, social media content E 408 may retrieved from a law enforcement database, such as a Records Management Service (RMS) and provides a social graph, such as a tree of ‘relatives/associates/group members’ relationships, or more simply, as depicted in FIG. 4, an indication that S_{A}, S_{B}, and S_{c} are related to each other.

In response to assembling cluster 402, user terminal 102, and in particular analytic engine 208, determines (306) a cluster-wide weight 410 for each of the attributes associated with one or more of social media contents of the cluster, that is, a cluster-wide source weight (W_{S}), a cluster-wide content location weight (W_{CL}), a cluster-wide source location weight (W_{SL}), a cluster-wide content time weight (W_{CT}), a cluster-wide posting time weight (W_{PT}), a cluster-wide victim weight (W_{V}), a cluster-wide perpetrator weight (W_{P}), and a cluster-wide event weight (W_{E}). In addition, or instead, analytic engine 208 may determine a weight 412 for each of the social media contents included in the cluster, for example, a social media content A weight (W_{SMC A}), a social media content B weight (W_{SMC B}), a social media content C weight (W_{SMC C}), and a social media content D weight (W_{SMC D}).

In one embodiment of the present invention, in determining a cluster-wide weight for an attribute, analytic engine 208 may review the values associated with that attribute across all social media contents in the cluster. Based on a correlation of the values reported for that attribute across all social media content in the cluster, analytic engine 208 then assigns a weight to that attribute. For example, a cluster-wide weight for the content location attribute W_{CL} may be determined based on the following formula:

W_{CL}=f(CL_{A},CL_{B},CL_{C},CL_{D}).

In one such embodiment, the cluster-wide attribute weight may be based on a percentage of the social media content that have related values for that attribute. When a large percentage of the social media content of the cluster have related values for that attribute, that is, when the attribute is being reported with a high correlation among the reported values, analytic engine 208 may assume that there is good reliability that the attribute is being accurately recorded and reported and assign a higher weight to that attribute. On the other hand, when a small percentage of the social media content of the cluster have related values for that attribute, that is, when the attribute is being reported with a low correlation among the reported values, analytic engine 208 may assume that there is poor reliability that the attribute is being accurately recorded and reported and assign a lower weight to that attribute.

In another such embodiment, a cluster-wide attribute weight may instead, or in addition, be based on the sources of the social media contents reporting that attribute. For example, when a source of a social media content is a public safety officer, such as a policeman or a fireman, or the social media content is retrieved from a public safety agency-maintained database, then attributes of social media content reported by that public safety officer or retrieved from that database may be assigned a high weight even if the values reported for that attribute, across all social media content in the cluster, have low correlation. That is, there may be a great deal of confidence in a value of an attribute when it is reported by a public safety officer or retrieved from a public safety agency-maintained database. On the other hand, when the sources of multiple social media contents are a same person (for example, a person who keeps re-tweeting the same or similar tweets) or are persons who are related to, or known associates of, each other, then that attribute may be assigned a low weight even if the values reported for that attribute have high correlation. For example, when the sources of multiple tweets are a same person, it would be expected that the values of an attribute would vary little from tweet to tweet. Or when the sources of multiple tweets are relatives of, or associates of, each other (e.g., fellow members of a gang), there is the possibility that the sources may be conspiring to report a pre-determined value for an attribute regardless of the value's accuracy.

In yet another embodiment of the present invention, a cluster-wide attribute weight may instead, or in addition, be based on a ‘posting time’ and/or ‘source location’ associated with the social media contents reporting that attribute. For example, suppose that there is low correlation among the values reported for an attribute across all social media contents in a cluster. If the social media contents have related values for their posting times and/or source locations, then a lower weight may be assigned to that attribute than might be assigned if the social media contents have very disparate values for their posting times and/or source locations (one may expect more variation in reported attribute values in the latter instance than in the former instance).

In another embodiment of the present invention, in determining a weight for an attribute, analytic engine 208 also may consider the individually assigned weights of each social media content of the cluster reporting that attribute, that is, weights W_{SMC A}, W_{SMC B}, W_{SMC C}, and W_{SMC D}. Analytic engine 208 then assigns a weight to that attribute, that is, W_{S}, W_{CL}, W_{SL}, W_{CT}, W_{PT}, W_{V}, and W_{P}, based on a compilation of the weights assigned to each social media content of the cluster reporting that attribute. For example, since each of social media content A, social media content B, social media content C, and social media content D reports a posting time (PT) attribute, the cluster-wide weight for the posting time attribute W_{PT} may be determined based on the following formula:

W_{PT}=f([PT_{A}×W_{SMC A}],[PT_{B}×W_{SMC B}],[PT_{C}×W_{SMC C}],[PT_{D}×W_{SMC D}]).

For example, as noted above, suppose a source of social media content A is a public safety officer, such as a policeman or a fireman, or social media content A is retrieved from a public safety agency-maintained database, then the values of attributes of social media content A, that is, S_{A}, CL_{A}, SL_{A}, CT_{A}, PT_{A}, V_{A}, P_{A}, and E_{A} may be assigned a weight W_{SMC A} that nearly assures that all such attributes are assigned high cluster-wide attribute weight (and a high reliability value that corresponds to the value reported by public safety officer or retrieved from the public safety agency-maintained database).

By way of another example, a social media content having a posting time concurrent to, or very close to, a time of a reported event, for example, social media content B, may be assigned a higher social media content weight, for example, W_{SMC B}, than a social media content weight assigned to a social media content, for example, social media content C and weight W_{SMC C}, having a posting time further removed from the time of the event. Similarly, social media contents having a source location very close to a location of a reported event may be assigned a higher social media content weight than social media contents having a source location that is farther removed from the location of the reported event.

By way of yet another example, a social media content whose content is reported as a fact may be assigned a higher social media content weight than a social media content whose content is reported as an opinion. Such a determination may be based on a type of the content, or may require a deeper digging into the content itself. For example, when a social media content comprises a video or an audio recording, then that social media content may be assigned a higher social media content weight than a social media content comprising a tweet or a Facebook© entry. That is, one may assume that a video or an audio recording is more likely to comprise a factual recording of an event than a tweet or a Facebook entry. By way of another example, if a social media content reports an attribute as a fact, for example, a tweet reporting that “I saw . . . ,” then that social media content may be assigned a higher social media content weight than a social media content that reports an attribute as an opinion, for example, a tweet reporting that “I heard from a friend that . . . .”

By way of still another example, a social media content whose source is a known source, that is, a person who has sourced social media content before, may be assigned a higher social media content weight than a social media content whose source is new. On the other hand, when the source of a social media content is a known source, then analytic agency 208 may, by reference to social media database 210, review a history of reliability of that source in order to assign a weight to the corresponding social media content. That is, more reliable the source has been in the past, the higher the social media content weight assigned to the currently received/retrieved social media content.

Based on the weight assigned to each social media content attribute, and/or to each social media content, included in the first ‘cluster’ 402, analytic engine 208 determines (308) a reliability level (RL) 414 of the cluster. The reliability level is an indication of a truthfulness and/or an accuracy of the social media contents of the cluster, for example, of the values of attributes included in the cluster. Analytic engine 208 further may determine (310) a range of values for the attributes included in the cluster and/or a reliability level for one or more of the values of the attributes.

In one embodiment of the present invention, the determined reliability level of the cluster may be an average of the weights assigned to all of attributes of the social media contents included in the cluster, for example, RL=f[avg(W_{S}, W_{CL}, W_{SL}, W_{CT}, W_{PT}, W_{V}, W_{P}, W_{E})]. In another embodiment of the present invention, the determined reliability level of the cluster may further consider that some attributes play a larger role than other attributes in determining the reliability level of the cluster, and correspondingly adjust an attribute weight of a more important attribute. Logic flow 300 then ends (312).

In another embodiment of the present invention, based on the determined reliability level of the received social media content and/or its parameters, analytic engine 208 may determine (314) whether to take further action with respect to the received social media content. For example, in one embodiment of the present invention, analytic engine 208 may compare the determined reliability level of the cluster to a reliability level threshold, maintained by at least one memory device 204, to produce a comparison. If the determined reliability level is less than the reliability level threshold, then logic flow 300 ends (312). However, if the determined reliability level is greater than the reliability level threshold, then analytic engine 208 may determine to generate a follow-up action to the review of the social media content. For example, in response to determining to generate a follow-up action, analytic engine 208 may generate an instruction to dispatch law enforcement officers to a location associated with the social media content or to a location associated with one of the persons identified in the social media content, and route the instruction to a Computer Aided Dispatch (CAD) controller.

In another embodiment of the present invention, a determination of whether to generate a follow-up action further may be based on an event associated with the social media content. For example, if the event is a ‘concert’ or an ‘athletic event,’ then analytic engine 208 may determine not to generate a follow-up action, regardless of the reliability level of the social media content. However, if the event is a ‘car theft,’ ‘robbery,’ or shooting,’ or if a person associated with the social media content, such as a source of the social media content or a person depicted in the social media content, identifies a party, such as a source of the social media content, who is a person that law enforcement officers are seeking to question, then analytic engine 208 may determine to generate a follow-up action if the reliability level of the social media content exceeds the reliability level threshold. When analytic engine 208 determines to generate a follow-up action, the analytic engine further may determine to update reliability levels of the other social media content, and/or of the parameters of the other social media content, based on the reliability level(s) determined for the received social media content, and logic flow diagram 300 then ends (312).

In yet another embodiment of the present invention, subsequent to forming a cluster, such as cluster 402, and determining a reliability level for the cluster, user terminal 102 may receive (316) additional social media content, for example, social media content F (SMC F) 416. When analytic engine 208 determines that social media content F is related to the social media contents A, B, C, D, E in cluster 402, for example, has values of one or more attributes that are related to values of attributes found in cluster 402, analytic engine 208 may add (318) social media content F 416 to cluster 402. For example, the additional social media content may have a same or related value for one or more of an event (E), a source (S), a victim (V), or a perpetrator (P) attribute, as one or more of social media contents A, B, C, D, E of cluster 402. A decision to add the additional social media content F 416 to cluster 402 may be automatically made by analytic engine 208, or may be performed by analytic engine 208 pursuant to an instruction received from a user of user terminal 102. For example, in one such embodiment, in response to receiving social media content F 416, user terminal 102 may inform a user of the user terminal of the receipt of social media content F. In response, user terminal 102 may receive an instruction from the user to add social media content F 416 to cluster 402. In another such embodiment, a user of user terminal 102 may input an instruction to the user terminal to retrieve additional social media content having a particular value for one or more of source (S), content location (CL), source location (SL), content time (CT), posting time (PT), victim (V), perpetrator (P), and event (E) attributes. In response to retrieving social media content that complies with that instruction, such as social media content F, analytic engine 208 may automatically, or in response to a further instruction from the user, add social media content F to cluster 402.

Analytic engine 208 then updates (320), the reliability level of the cluster 402 based on the addition of social media content F to the cluster, and logic flow diagram 300 ends (312). For example, analytic engine 208 may compare the attribute values of social media content F to the attribute values of the other social media contents (A, B, C, D) in the cluster. When there is a high correlation between the values of the attributes of social media content F and one or more social media contents of cluster 402, then the social media content F may be considered as verification of the social media content of cluster 402 and the reliability level of the cluster may be increased. On the other hand, when there is a low correlation between the values of the attributes of social media content F and the values of the attributes of the social media contents of cluster 402, for example, then social media content F may be considered as failing to verify the social media contents of cluster 402 and a reliability level of the cluster may be left unchanged or may be decreased.

In another embodiment of the present invention, a relationship between a source of first social media content F and one or more sources of the social media content of cluster 402 may be given special consideration when updating (320) the reliability level of the cluster. For example, suppose there is a high correlation between values of the attributes of social media content F and values of the attributes of one or more social media contents (A, B, C, D) of cluster 402, for example, social media contents A and B. Further suppose that a value of the source attribute (e.g., a person sourcing) of social media content F is unrelated to the values of the source attributes (e.g., persons sourcing) of social media contents A and B. In such an instance, a reliability level of cluster 402 may be increased, as social media content F may be considered to be an independent confirmation of social media contents A and B.

By way of another example, again suppose there is a high correlation between values of the attributes of social media content F and values of the attributes of one or more social media contents (A, B, C, D) of cluster 402, again for example, social media contents A and B. However, this time a value of the source attribute of social media content F and the values of the source attributes (e.g., persons sourcing) of social media contents A and B are related, for example, are relatives or known associates of each other. In such an instance, a reliability level of cluster 402 may be left unchanged, as social media content F may be considered to be lacking in independence from submitted social media contents A and B.

By way of yet another example, suppose there is a low correlation between the values of the attributes of social media content F and values of the attributes of social media contents A, B, C, and D of cluster 402. In such an instance, a reliability level of cluster 402 may be decreased regardless of whether the value of the source attribute of the social media content F is related to the value of a source attribute of social media contents A, B, C, or D. For example, one might assume that if two sources are related and scheming together, then there would be a high correlation between the social media content, so if there is a low correlation between the social media content then it is more likely that sources are reporting what they think that they actually witnessed.

Further, cluster 402 also may have its reliability level updated when social media content comprising actual data, such as police reports, historical data (for example, past reliability of a person or of blogs, emails, or tweets of that person), court decisions, or newly discovered relationships (for example, a person may be considered to provide less reliable information about a criminal activity of a cousin or friend than of a third party who is not personally known) is obtained. For example, such data may confirm the values of the attributes of the social media contents of cluster 402, resulting in an increase of the reliability level of the cluster, or such data may conflict with the values of the attributes of the social media contents of cluster 402, resulting in an decrease in the reliability level of the cluster.

In still another embodiment of the present invention, subsequent to forming a cluster, such as cluster 402, and determining a reliability level for the cluster, analytic engine 208 may create (322) a second, new cluster 420 of social media content based on the values of the attributes of the social media contents (A, B, C, D, E) of cluster 402. For example, analytic engine 208 may execute a search, via user query converter 206, of databases 122, 132, and 142 for social media content, such as social media content G 422 and social media content H 424, that have an attribute value that is related to a value of that attribute of one or more of social media contents A, B, C, D, and E.

For example, analytic engine 208 may execute a search of databases 122, 132, and 142 for other social media content, that is, not yet included in cluster 402, having a value for a source (S) or perpetrator (P) attribute that is related to the value of the attribute associated with one or more of social media contents A, B, C, D (for example, looking for other incidents that may have been perpetrated by a perpetrator identified by one or more of the social media contents of cluster 402). By way of another example, analytic engine 208 may execute a search of databases 122, 132, and 142 for other social media content having values for both content location (CL) attribute and content time (CT) attributes that are related to the values of the content location (CL) and the content time (CT) attributes of one or more of social media contents A, B, C, D (for example, looking for other observers of an incident reported by the social media contents of cluster 402, or looking for other incidents that may have occurred around the time and location of an incident reported by the social media contents of cluster 402).

Analytic engine 208 then may determine (324) cluster-wide attribute weights 426 and a reliability level 430 for cluster 420 in a manner similar to the determination of cluster-wide attribute weights 410 and the reliability level 414 for cluster 402. Optionally, analytic engine 208 also may determine a weight 428 for each social media content of the cluster 420 reporting a particular attribute, that is, weights W_{SMC G} and W_{SMC H}, in a manner similar to the determination of social media content weights 412.

Based on the elements of clusters 402 and 420, that is, social media contents A-E of cluster 402 and social media contents G-H of cluster 420, and on their attribute values, and optionally further based on one or more of cluster-wide attribute weights 410 and 426 and cluster reliability levels 414 and 430, analytic engine 208 may predict (326) a reliability of other, and possibly future, social media content that is not included in either the first or second cluster 402, 420. For example, processor 202 may execute well-known pattern recognition software maintained in at least one memory device 204 to detect a pattern of social behavior based social media contents A-E and G-H and their corresponding attribute values. Further, based on the detected pattern, processor 202, via execution of the pattern recognition software, may predict a range of possible future events and further determine a likelihood of each such future event based on the one or more of cluster-wide attribute weights 410 and 426 and cluster reliability levels 414 and 430.

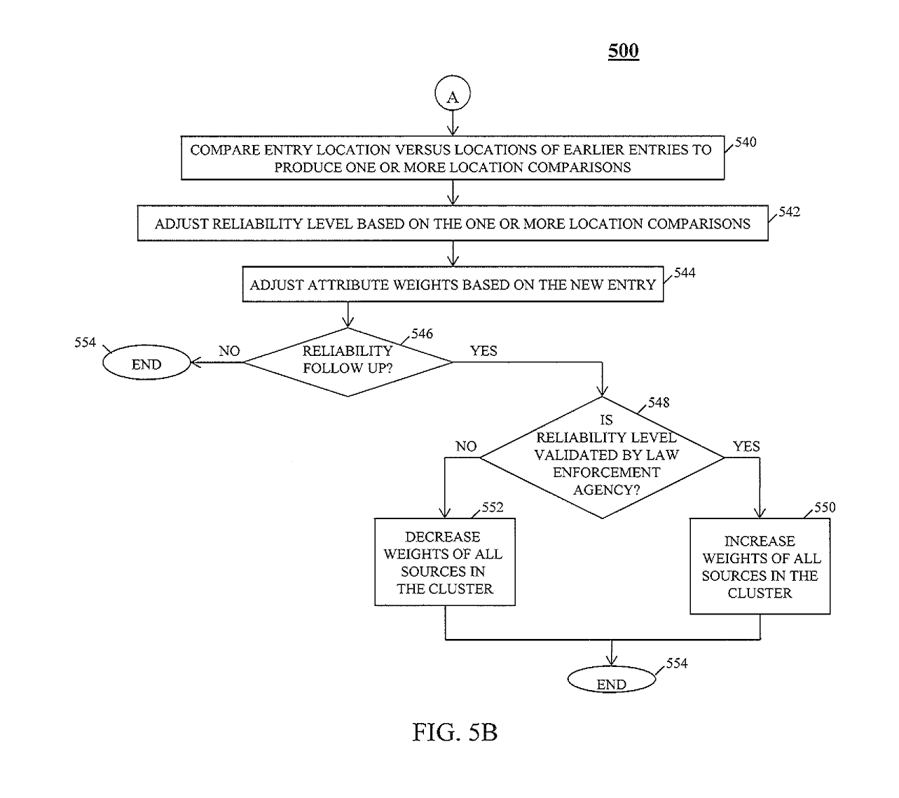

Referring now to FIGS. 5A and 5B, a logic flow diagram 500 is provided that illustrates an exemplary method performed by user terminal 102 in determining, and updating, reliability levels and individual and cluster-wide attribute weights in accordance with some embodiments of the present invention. Logic flow diagram 500 begins (502) when user terminal 102 receives (504) multiple social media contents. For example, suppose an event, such as a drive-by shooting, just occurred. In order to find out information about the event, user terminal 102, and in particular user query converter 206, may search databases 122, 132, and 142 to retrieve social media contents associated with a same, or a related, time and location as the event. In response to searching the databases, user terminal 102, and in particular analytic engine 208, receives multiple social media contents. Analytic engine 208 then assembles (506) a cluster associated with the received multiple social media contents and determines associated reliability levels and weights as described above.

As new, related social media contents are received, analytic engine 208 then adds (510) each such social media content to the cluster and evaluates a weight and an impact (for example, a resulting reliability level adjustment) on the cluster, of the social media content. In evaluating the new social media content, analytic engine 208 determines (510) whether the new social media content is a first entry in the cluster from a source of the new social media content, for example, a person who has posted the social media content.

When this is a first entry for that source, analytic engine 208 determines (512) whether the source is a relative of, or associate of, a source of other social media content in the cluster. If, at step 512, the source of the new social media content is a known relative of, or associate of, a source of other social media content in the cluster, then analytic engine 208 determines (514) whether the source of the new social media content is a blood relative of the source of the other social media content. It is assumed herein that an associate, for example, a fellow gang member, is more likely to collaborate in social media postings than a relative. Therefore, if the source of the new social media content is a blood relative of the source of the other social media content, then analytic engine 208 reviews (516), if available and by reference to social media database 210, a history of weights associated with the source of the new social media content and leaves (518) the new social media content source's weight unchanged. However, if the source of the new social media content is an associate of the source of the other social media content, then analytic engine 208 reviews (520), if available and by reference to social media database 210, a history of weights associated with the source of the new social media content, reduces (522) the weight associated with the new social media content source, and stores the reduced weight in social media database 210.

If, at step 512, the source of the social media content is not a known relative of, or associate of, the party, then analytic engine 208 reviews (524), if available and by reference to social media database 210, a history of weights associated with the source of the other social media content, leaves (526) the new social media content source's weight unchanged.

If, at step 510, analytic engine 208 determines that the social media content is not a first entry in the cluster from the source of the new social media content, then analytic engine 208 determines (528) whether all entries in the cluster, that is, all other social media content in the cluster, are from known relatives of, or associates of, the source of the new social media content.

If, at step 528, all entries in the category are from known relatives of, or associates of, the source of the new social media content, then analytic engine 208 reviews (530), if available and by reference to social media database 210, a history of the weights associated with the source of the new social media content and leaves (532) the new social media content source's weight unchanged.

If, at step 528, not all entries in the category are from known relatives of, or associates of, the party, then analytic engine 208 determines (534) whether the source of the new social media content is a relative of, or associate of, a source of other social media content in the cluster. If, at step 532, the source of the new social media content is not a known relative of, or associate of, a source of other social media content in the cluster, then analytic engine 208 assigns (536) a high weight to the source of the new social media content and stores the weight in social media database 210, as the source of the new social media content is more likely to be impartial in posting the new social media content.

If, at step 534, the source of the social media content is a known relative of, or associate of, the party, then analytic engine 208 assigns (538) an even higher weight (higher than at step 536) to the source of the new social media content and stores the weight in social media database 210. For example, if there are no entries for a given event, one might look at the first entry with some extra focus. Specifically, a relative or an associate could be trying to give accurate or misleading information. Either way, there is a high probability that the information is linked to the situation, and it should be verified as quickly as possible to be used as a baseline as more social media content is received/retrieved by user terminal 102.

After assigning, adjusting, or leaving unchanged a weight associated the source of the new social media content, analytic engine 208 compares (540) a location associated with the received new social media content, for example, a location where the incident occurred, to locations associated with other social media content in the cluster, if any, to produce one or more comparisons. Analytic engine 208 then may adjust (542) the reliability level of the cluster based on the one or more comparisons, for example, increasing a reliability level when the location associated with the new social media content matches locations associated with one or more other social media content in the cluster, and reducing a reliability level associated with the received new social media content when the location associated with the new social media content does not match a location associated with other social media content in the cluster. Analytic engine 208 further may adjust (544) cluster-wide weights associated with attributes of the cluster, for example, based on whether values of attributes of the received new social media content affirms or contradicts the values of such attributes of the other social media content in the cluster, such as a location of the content, a victim, a perpetrator, a time associated with the content, and so on.

Based on any adjustments to the reliability level of the cluster or cluster-wide weights associated with attributes of the cluster, analytic engine 208 may determine (546) whether to generate a follow-up action. When analytic engine 208 determines not to generate a follow-up action, logic flow diagram 500 then ends (554). When analytic engine 208 determines to generate a follow-up action, the analytic engine may then determine (548) whether adjusted reliability level is validated by actual data, such as police reports, historical data (for example, past reliability of a person or of blogs, emails, or tweets of that person), court decisions, known relationships (for example, a person may be considered to provide less reliable information about a criminal activity of a cousin or friend than of a third party who is not personally known). If the adjusted reliability level determined for received social media content is validated by actual data, then analytic engine 208 may increase (550) a weight associated with each source of social media content in the cluster. If the reliability level determined for received social media content is not validated by actual data, then analytic engine 208 may decrease (552) a weight associated with each source of social media content in the cluster. Logic flow diagram 500 then ends (554).

Thus, communication system 100 provides an informational tool for law enforcement agencies to track current events and research past incidents by determining a reliability level associated with cluster of multiple social media contents, which determined reliability level can be utilized to generate further actions, such as dispatching law enforcement officers to a location or to search for a person, or to predict a reliability level of further social media content. The reliability level is determined based on weights associated with the social media contents included in the cluster, and in various embodiments may include determining a weight associated with each of one or more attributes shared by two or more of the multiple social media contents of the cluster and/or a social media content weight for each of two or more social media contents sharing an attribute. In still other embodiments, communication system 100 may re-determine the reliability level in response to adding new social media content to the cluster.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for analyzing social media, the method comprising:
assembling a cluster of a plurality of social media contents, wherein each social media content of the plurality of social media contents has one or more associated attributes;
determining weights in association with the social media contents included in the cluster; and
determining a reliability level of the cluster based on the determined weights.

2. The method of claim 1, wherein determining weights comprises:
determining one or more attributes shared by two or more of the plurality of social media contents of the cluster; and
determining a weight associated with each of the one or more shared attributes.

3. The method of claim 2, wherein determining a weight associated with an attribute shared by two or more of the plurality of social media contents comprises:
determining a social media content weight for each of the two or more of the plurality of social media contents sharing the attribute; and
determining the weight associated with the shared attribute based on:
a value of the attribute associated with each of the two or more of the plurality of social media contents; and
the determined social media content weight associated with each of the two or more of the plurality of social media contents sharing the attribute.

4. The method of claim 1, wherein determining weights in association with the social media contents included in the cluster comprises determining a social media content weight for one or more of the plurality of social media contents.

5. The method of claim 1, further comprising determining whether to take further action based on the determined reliability level.

6. The method of claim 5, wherein determining whether to take further action based on the determined reliability level comprises:
comparing the determined reliability level to a threshold to produce a comparison; and
determining whether to take further action based on the comparison.

7. The method of claim 1, further comprising:
receiving social media content not included in the cluster;
adding the received social media content to the cluster; and
re-determining the reliability level of the cluster based on the addition of the received social media content to the cluster.

8. The method of claim 7, wherein adding the received social media content to the cluster comprises determining that one or more attributes of the received social media content not included in the cluster is related to one or more attributes of the plurality of social media content included in the cluster.

9. The method of claim 8, wherein re-determining the reliability level of the cluster comprises re-determining the reliability level of the cluster based on a correlation between one or more one or more attributes of the received social media content not included in the cluster and one or more attributes of the plurality of social media content included in the cluster.

10. The method of claim 1, wherein the cluster is a first cluster and wherein the method further comprises:
creating a second cluster of social media content based on the social media content included in the first cluster;
determining a reliability level of the second cluster; and
predicting a reliability of further social media content not included in the first or second cluster based on the reliability levels of the first and second clusters.

11. A user terminal comprising
a user interface; and
a processor that is configured to
assemble a cluster of a plurality of social media contents, wherein each social media content of the plurality of social media contents has one or more associated attributes;
determine weights in association with the social media contents included in the cluster; and
determine a reliability level of the cluster based on the determined weights.

12. The user terminal of claim 11, wherein the processor is configured to determine weights by:
determining one or more attributes shared by two or more of the plurality of social media contents of the cluster; and
determining a weight associated with each of the one or more shared attributes.

13. The user terminal of claim 12, wherein the processor is configured to determine a weight associated with an attribute shared by two or more of the plurality of social media contents by:
determining a social media content weight for each of the two or more of the plurality of social media contents sharing the attribute; and
determining the weight associated with the shared attribute based on:
a value of the attribute associated with each of the two or more of the plurality of social media contents; and
the determined social media content weight associated with each of the two or more of the plurality of social media contents sharing the attribute.

14. The user terminal of claim 11, wherein the processor is configured to determine weights in association with the social media contents included in the cluster by determining a social media content weight for one or more of the plurality of social media contents.

15. The user terminal of claim 11, further comprising determining whether to take further action based on the determined reliability level.

16. The user terminal of claim 15, wherein the processor is configured to determine whether to take further action based on the determined reliability level by:
comparing the determined reliability level to a threshold to produce a comparison; and
determining whether to take further action based on the comparison.

17. The user terminal of claim 11, wherein the processor further is configured to:
receive social media content not included in the cluster;
add the received social media content to the cluster; and
re-determine the reliability level of the cluster based on the addition of the received social media content to the cluster.

18. The user terminal of claim 17, wherein the processor is configured to add the received social media content to the cluster by determining that one or more attributes of the received social media content not included in the cluster is related to one or more attributes of the plurality of social media content included in the cluster.

19. The user terminal of claim 18, wherein the processor is configured to re-determine the reliability level of the cluster comprises re-determining the reliability level of the cluster based on a correlation between one or more one or more attributes of the received social media content not included in the cluster and one or more attributes of the plurality of social media content included in the cluster.

20. The user terminal of claim 11, wherein the cluster is a first cluster and wherein the processor further is configured to:
create a second cluster of social media content based on the social media content included in the first cluster;
determine a reliability level of the second cluster; and
predict a reliability of further social media content not included in the first or second cluster based on the reliability levels of the first and second clusters.
